(19) United States
(12) Patent Application Publication
(10) Pub. No.: US 2024/0284906 A1
(43) Pub. Date: Aug. 29, 2024

(54) HERBICIDAL COMPOSITIONS CONTAINING CINMETHYLINE AND ETHOFUMESATE

(71) Applicant: BAYER AKTIENGESELLSCHAFT, LEVERKUSEN (DE)

(72) Inventors: Thomas AULER, Leverkusen (DE); Udo BICKERS, Leverkusen (DE); Herve TOSSENS, Leverkusen (DE)

(21) Appl. No.: 18/570,754

(22) PCT Filed: Jun. 28, 2022
(86) PCT No.: PCT/EP2022/067648

§ 371 Date: Dec. 15, 2023

(30) Foreign Application Priority Data
Jul. 2, 2021 (EP) 21183576.4

(51) Int. Cl. A01N 43/12; A01P 13/00

(52) U.S. Cl. CPC A01N 43/12; A01P 13/00

(57) ABSTRACT

Herbicidal compositions comprising the active ingredients cinmethylin and ethofumesate are described. These herbicidal compositions are particularly suitable for use against harmful plants in crops of useful plants.

The present invention relates to agrochemically active herbicidal compositions and to the use thereof for control of harmful plants.

Cinmethylin (CAS RN 87818-31-3) is a racemic mixture of (+/−)-2-exo-(2-methylbenzyloxy)-1-methyl-4-isopropyl-7-oxabicyclo[2.2.1]heptane.

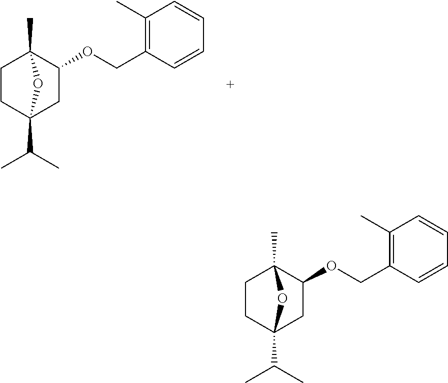 [SMILES: Cc1ccccc1CO[C@@H]1C[C@]2(C(C)C)CC[C@@]1(C)O2 ; Cc1ccccc1CO[C@H]1C[C@@]2(C(C)C)CC[C@]1(C)O2]

The ratio of the two enantiomers to one another here is roughly even. The preparation of the enantiomerically enriched compounds is known from EP 0 081 893 A2.

Ethofumesate (CAS 26225-79-6) is a chemical compound from the group of benzofurans which is used as a selective systemic herbicide.

Various documents disclose herbicidal compositions comprising cinmethylin and further herbicides, for example: WO 2017/009054 A1, WO 2017/009056 A1, WO 2017/009060 A1, WO 2017/009061 A1, WO 2017/009089 A1, WO 2017/009090 A1, WO 2017/009092 A1, WO 2017/009095 A1, WO2017009124A1, WO 2017/009134 A1, WO 2017/009137 A1, WO 2017/009138 A1, WO 2017/009139 A1, WO 2017/009140 A1, WO 2017/009142 A1, WO 2017/009143 A1, WO 20177009144 A1, WO 2017/009145 A1, WO 2017/009146 A1, WO 2017/009147 A1. These herbicidal compositions extend the weed spectrum to be controlled by comparison with the respective individual active ingredients, but without opening up further possible applications, such as use in different crops of useful plants or movement of the application period. Nor do these herbicidal compositions known from the prior art solve the problem of increasing resistance formation of harmful plants to active herbicidal ingredients from the group of the HPPD inhibitors, which also include cinmethylin.

It is therefore an object of the present invention to provide further herbicidal compositions that enable good control of unwanted plants in various crops of useful plants in user-friendly time windows.

This object was achieved by the provision of herbicidal compositions comprising cinmethylin and ethofumesate.

The present invention thus provides herbicidal compositions comprising
(A) cinmethylin (component A), and
(B) ethofumesate (component B).

Preference is given to herbicidal compositions comprising, as the sole active herbicidal ingredients,
(A) cinmethylin, and
(B) ethofumesate.

The herbicidal compositions according to the invention may additionally comprise or be used together with further components, for example other kinds of active crop protection ingredients and/or additives and/or formulation auxiliaries customary in crop protection. Preference is given to herbicidal compositions comprising cinmethylin and ethofumesate as the sole active agrochemical ingredients.

The herbicidal compositions according to the invention surprisingly show not just a synergistic effect toward unwanted harmful plants, but additionally further exceptional properties: For instance, they are applicable within a broad time window in crops of useful plants against unwanted harmful plants without significant damage to the useful plants.

The herbicidal compositions according to the invention can be applied in a manner known to the person skilled in the art, for example together (for example as a co-formulation or as a tank-mix) or else at different times in short succession (splitting), for example to the plants, plant parts, plant seeds or the area in which the plants grow. It is possible, for example, to apply the individual active ingredients or the herbicidal compositions in two or more portions (sequential application), for example by pre-emergence applications followed by post-emergence applications or by early post-emergence applications followed by medium or late post-emergence applications. Preference is given here to the joint or successive application of components A and B. Preference is likewise given to application by a pre-emergence to early post-emergence method.

In the herbicidal compositions according to the invention, the application rate of cinmethylin (component A) is typically 10 to 1000 g of active ingredient (a.i.) per hectare, preferably 200 to 500 g a.i./ha. The application rate of ethofumesate (component B) is typically 10 to 500 g of active ingredient per hectare, preferably 100 to 250 g a.i./ha.

The synergistic effect of the herbicidal compositions according to the invention is particularly marked in particular concentration ratios. However, the weight ratios of components A and B can be varied within relatively wide ranges. In general, for 1 part by weight of cinmethylin active ingredient, there are 0.1 to 10 parts by weight, preferably 0.2 to 2 parts by weight, of ethofumesate.

On application of the herbicidal compositions according to the invention, a very broad spectrum of harmful plants is controlled pre-emergence and post-emergence, for example annual and perennial mono- or dicotyledonous weeds and unwanted crop plants. The herbicidal compositions according to the invention are particularly suitable for use in crops such as cereals, maize, rice, soya, oilseed rape, sugar beet, cotton, sugar cane, and also for use in perennial crops, plantations and on uncultivated land. Preference is given to the use thereof in crops of cereals.

The present invention thus further provides a method of controlling unwanted plants in plant crops, which is characterized in that components A and B of the herbicidal compositions according to the invention are deployed, for example separately or together, onto the plants (for example harmful plants such as mono- or dicotyledonous weeds or unwanted crop plants) or the area in which the plants grow.

Unwanted plants are understood to mean all plants growing at sites where they are unwanted. These may be, for example, harmful plants (e.g. mono- or dicotyledonous weeds or unwanted crop plants).

Monocotyledonous weeds come, for example, from the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus, Apera. Dicotyledonous weeds come, for example, from the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoea, Polygonum, Sesbania, Ambrosia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum, Euphorbia.

The invention also provides for the use of the herbicidal compositions according to the invention for control of unwanted plant growth, preferably in crops of useful plants.

The herbicidal compositions according to the invention can be produced by known processes, for example as mixed formulations of the individual components, optionally with further active ingredients, additives and/or customary formulation auxiliaries, and these are then applied in a customary manner diluted with water, or as tankmixes by joint dilution of the separately formulated or partly separately formulated individual components with water. Likewise possible is the application at different times (split application) of the separately formulated or partly separately formulated individual components. It is also possible to apply the individual components or the herbicidal compositions in a plurality of portions (sequential application), for example by pre-emergence applications followed by post-emergence applications or by early post-emergence applications followed by medium or late post-emergence applications. Preference is given to the joint or immediately successive application of the active ingredients in the respective combination.

The present invention further provides herbicidal compositions comprising
(A) cinmethylin, and
(B) ethofumesate
   and additionally
(C) a safener.

The present invention further provides herbicidal compositions comprising, as the sole active herbicidal ingredients,
(A) cinmethylin, and
(B) ethofumesate
   and additionally
(C) a safener.

In the herbicidal compositions according to the invention, the application rate of the safener (component C) is typically 10 to 500 g of active ingredient (a.i.) per hectare, preferably 50 to 250 g a.i./ha.

Examples of useful safeners include the following groups of compounds:
S1) Compounds from the group of heterocyclic carboxylic acid derivatives:
S1^{a}) Compounds of the dichlorophenylpyrazoline-3-carboxylic acid type (S1^{a}), preferably compounds such as
   1-(2,4-dichlorophenyl)-5-(ethoxycarbonyl)-5-methyl-2-pyrazoline-3-carboxylic acid, ethyl 1-(2,4-dichlorophenyl)-5-(ethoxycarbonyl)-5-methyl-2-pyrazoline-3-carboxylate (S1-1) (“mefenpyr-diethyl”), and related compounds as described in WO-A-91/07874;
S1^{b}) Derivatives of dichlorophenylpyrazolecarboxylic acid (S1^{b}), preferably compounds such as ethyl 1-(2,4-dichlorophenyl)-5-methylpyrazole-3-carboxylate (S1-2), ethyl 1-(2,4-dichlorophenyl)-5-isopropylpyrazole-3-carboxylate (S1-3), ethyl 1-(2,4-dichlorophenyl)-5-(1,1-dimethylethyl)pyrazole-3-carboxylate (S1-4) and related compounds as described in EP-A-333 131 and EP-A-269 806;
S1^{c}) Derivatives of 1,5-diphenylpyrazole-3-carboxylic acid (S1^{c}), preferably compounds such as ethyl 1-(2,4-dichlorophenyl)-5-phenylpyrazole-3-carboxylate (S1-5), methyl 1-(2-chlorophenyl)-5-phenylpyrazole-3-carboxylate (S1-6) and related compounds as described, for example, in EP-A-268554;
S1^{d}) Compounds of the triazolecarboxylic acids type (S1^{d}), preferably compounds such as fenchlorazole (ethyl ester), i.e. ethyl 1-(2,4-dichlorophenyl)-5-trichloromethyl-(1H)-1,2,4-triazole-3-carboxylate (S1-7), and related compounds as described in EP-A-174 562 and EP-A-346 620;
S1^{e}) Compounds of the 5-benzyl- or 5-phenyl-2-isoxazoline-3-carboxylic acid or of the 5,5-diphenyl-2-isoxazoline-3-carboxylic acid type (S1^{e}), preferably compounds such as ethyl 5-(2,4-dichlorobenzyl)-2-isoxazoline-3-carboxylate (S1-8) or ethyl 5-phenyl-2-isoxazoline-3-carboxylate (S1-9) and related compounds as described in WO-A-91/08202, or 5,5-diphenyl-2-isoxazolinecarboxylic acid (S1-10) or ethyl 5,5-diphenyl-2-isoxazoline-3-carboxylate (S1-11) (“isoxadifen-ethyl”) or n-propyl 5,5-diphenyl-2-isoxazoline-3-carboxylate (S1-12) or ethyl 5-(4-fluorophenyl)-5-phenyl-2-isoxazoline-3-carboxylate (S1-13) as described in patent application WO-A-95/07897.
S2) Compounds from the group of the 8-quinolinoxy derivatives (S2):
S2^{a}) Compounds of the 8-quinolinoxyacetic acid type (S2^{a}), preferably 1-methylhexyl (5-chloro-8-quinolinoxy)acetate (“cloquintocet-mexyl”) (S2-1), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5),
methyl (5-chloro-8-quinolinoxy)acetate (S2-6),
allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds as described in EP-A-86 750, EP-A-94 349 and EP-A-191 736 or EP-A-0 492 366, and also (5-chloro-8-quinolinoxy)acetic acid (S2-10), hydrates and salts thereof, for example the lithium, sodium, potassium, calcium, magnesium, aluminium, iron, ammonium, quaternary ammonium, sulfonium or phosphonium salts thereof, as described in WO-A-2002/34048;
S2^{b}) Compounds of the (5-chloro-8-quinolinoxy)malonic acid type (S2^{b}), preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds, as described in EP-A-0 582 198.
S3) Active ingredients of the dichloroacetamide type (S3), which are frequently used as pre-emergence safeners (soil-acting safeners), for example
“dichlormid” (N,N-diallyl-2,2-dichloroacetamide) (S3-1),
“R-29148” (3-dichloroacetyl-2,2,5-trimethyl-1,3-oxazolidine) from Stauffer (S3-2),
“R-28725” (3-dichloroacetyl-2,2-dimethyl-1,3-oxazolidine) from Stauffer (S3-3),
“benoxacor” (4-dichloroacetyl-3,4-dihydro-3-methyl-2H-1,4-benzoxazine) (S3-4),
“PPG-1292” (N-allyl-N-[(1,3-dioxolan-2-yl)methyl]dichloroacetamide) from PPG Industries (S3-5),
“DKA-24” (N-allyl-N-[(allylaminocarbonyl)methyl]dichloroacetamide) from Sagro-Chem (S3-6),
“AD-67” or “MON 4660” (3-dichloroacetyl-1-oxa-3-azaspiro[4.5]decane) from Nitrokemia or Monsanto (S3-7),
“TI-35” (1-dichloroacetylazepane) from TRI-Chemical RT (S3-8),
“diclonon” (dicyclonon) or “BAS145138” or “LAB145138” (S3-9)
((RS)-1-dichloroacetyl-3,3,8a-trimethylperhydropyrrolo[1,2-a]pyrimidin-6-one) from BASF,
“furilazole” or “MON 13900” ((RS)-3-dichloroacetyl-5-(2-furyl)-2,2-dimethyloxazolidine) (S3-10), and the (R) isomer thereof (S3-11).
S4) Compounds from the class of the acylsulfonamides (S4):
S4^{a})N-Acylsulfonamides of the formula (S4^{a}) and salts thereof, as described in WO-A-97/45016,

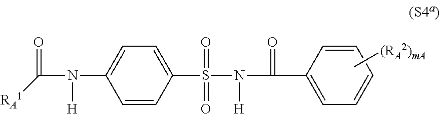

in which
R_{A}¹ is (C₁-C₆)-alkyl, (C₃-C₆)-cycloalkyl, where the 2 latter radicals are substituted by v_{A} substituents from the group of halogen, (C₁-C₄)-alkoxy, (C₁-C₆)-haloalkoxy and (C₁-C₄)-alkylthio and, in the case of cyclic radicals, also by (C₁-C₄)-alkyl and (C₁-C₄)-haloalkyl;
R_{A}² is halogen, (C₁-C₄)-alkyl, (C₁-C₄)-alkoxy, CF₃;
m_{A} is 1 or 2;
v_{A} is 0, 1, 2 or 3;
S4^{b}) Compounds of the 4-(benzoylsulfamoyl)benzamide type of the formula (S4b) and salts thereof, as described in WO-A-99/16744,

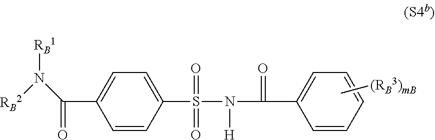

in which
R_{B}¹, R_{B}² are independently hydrogen, (C₁-C₆)-alkyl, (C₃-C₆)-cycloalkyl, (C₃-C₆)-alkenyl, (C₃-C₆)-alkynyl,
R_{B}³ is halogen, (C₁-C₄)-alkyl, (C₁-C₄)-haloalkyl or (C₁-C₄)-alkoxy and
m_{B} is 1 or 2,
e.g. those in which
R_{B}¹=cyclopropyl, R_{B}²=hydrogen and (R_{B}³)=2-OMe (“cyprosulfamide”, S4-1),
R_{B}¹=cyclopropyl, R_{B}²=hydrogen and (R_{B}³)=5-Cl-2-OMe (S4-2),
R_{B}¹=ethyl, R_{B}²=hydrogen and (R_{B}³)=2-OMe (S4-3),
R_{B}¹=isopropyl, R_{B}²=hydrogen and (R_{B}³)=5-Cl-2-OMe (S4-4) and
R_{B}¹=isopropyl, R_{B}²=hydrogen and (R_{B}³)=2-OMe (S4-5);
S4^{c}) Compounds from the class of the benzoylsulfamoylphenylureas of the formula (S4^{c}), as described in EP-A-365484,

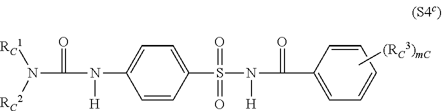

in which
R_{C}¹, R_{C}² are independently hydrogen, (C₁-C₈)-alkyl, (C₃-C₈)-cycloalkyl, (C₃-C₆)-alkenyl, (C₃-C₆)-alkynyl,
R_{C}³ is halogen, (C₁-C₄)-alkyl, (C₁-C₄)-alkoxy, CF₃ and
m_{C} is 1 or 2;
for example
1-[4-(N-2-methoxybenzoylsulfamoyl)phenyl]-3-methylurea,
1-[4-(N-2-methoxybenzoylsulfamoyl)phenyl]-3,3-dimethylurea,
1-[4-(N-4,5-dimethylbenzoylsulfamoyl)phenyl]-3-methylurea;
S4^{d}) Compounds of the N-phenylsulfonylterephthalamide type of the formula (S4^{d}) and salts thereof, which are known, for example, from CN 101838227,

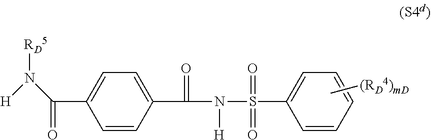

in which
R_{D}⁴ is halogen, (C₁-C₄)-alkyl, (C₁-C₄)-alkoxy, CF₃;
m_{D} is 1 or 2;
R_{D}⁵ is hydrogen, (C₁-C₆)-alkyl, (C₃-C₆)-cycloalkyl, (C₂-C₆)-alkenyl, (C₂-C₆)-alkynyl, (C₅-C₆)-cycloalkenyl.
S5) Active ingredients from the class of the hydroxyaromatics and the aromatic-aliphatic carboxylic acid derivatives (S5), for example ethyl 3,4,5-triacetoxybenzoate, 3,5-dimethoxy-4-hydroxybenzoic acid, 3,5-dihydroxybenzoic acid, 4-hydroxysalicylic acid, 4-fluorosalicyclic acid, 2-hydroxycinnamic acid, 2,4-dichlorocinnamic acid, as described in WO-A-2004/084631, WO-A-2005/015994, WO-A-2005/016001.
S6) Active ingredients from the class of the 1,2-dihydroquinoxalin-2-ones (S6), for example 1-methyl-3-(2-thienyl)-1,2-dihydroquinoxalin-2-one, 1-methyl-3-(2-thienyl)-1,2-dihydroquinoxaline-2-thione, 1-(2-aminoethyl)-3-(2-thienyl)-1,2-dihydroquinoxalin-2-one hydrochloride, 1-(2-methylsulfonylaminoethyl)-3-(2-thienyl)-1,2-dihydroquinoxalin-2-one, as described in WO-A-2005/112630.
S7) Compounds from the class of the diphenylmethoxyacetic acid derivatives (S7), e.g. methyl diphenylmethoxyacetate (CAS Reg. No. 41858-19-9) (S7-1), ethyl diphenylmethoxyacetate or diphenylmethoxyacetic acid, as described in WO-A-98/38856.
S8) Compounds of the formula (S8), as described in WO-A-98/27049,
   in which the symbols and indices are defined as follows:

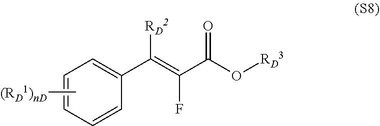

R_{D}¹ is halogen, (C₁-C₄)-alkyl, (C₁-C₄)-haloalkyl, (C₁-C₄)-alkoxy, (C₁-C₄)-haloalkoxy,
R_{D}² is hydrogen or (C₁-C₄)-alkyl,
R_{D}³ is hydrogen, (C₁-C₈)-alkyl, (C₂-C₄)-alkenyl, (C₂-C₄)-alkynyl or aryl, where each of the aforementioned carbon-containing radicals is unsubstituted or substituted by one or more, preferably up to three, identical or different radicals from the group consisting of halogen and alkoxy; or salts thereof,
n_{D} is an integer from 0 to 2.
S9) Active ingredients from the class of the 3-(5-tetrazolylcarbonyl)-2-quinolones (S9), for example 1,2-dihydro-4-hydroxy-1-ethyl-3-(5-tetrazolylcarbonyl)-2-quinolone (CAS Reg. No.: 219479-18-2), 1,2-dihydro-4-hydroxy-1-methyl-3-(5-tetrazolylcarbonyl)-2-quinolone (CAS Reg. No. 95855-00-8), as described in WO-A-1999/000020.
S10) Compounds of the formulae (S10^{a}) or (S10^{b})
   as described in WO-A-2007/023719 and WO-A-2007/023764
      in which

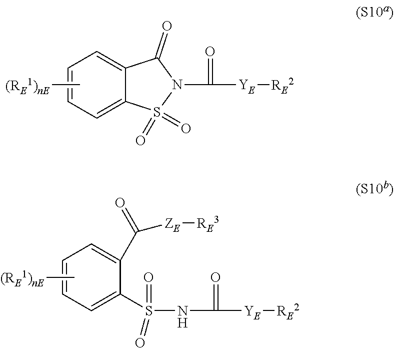

R_{E}¹ is halogen, (C₁-C₄)-alkyl, methoxy, nitro, cyano, CF₃, OCF₃,
Y_{E}, Z_{E} are independently O or S,
n_{E} is an integer from 0 to 4,
R_{E}² is (C₁-C₁₆)-alkyl, (C₂-C₆)-alkenyl, (C₃-C₆)-cycloalkyl, aryl; benzyl, halobenzyl,
R_{E}³ is hydrogen or (C₁-C₆)-alkyl.
S11) Active ingredients of the oxyimino compound type (S11), which are known as seed-dressing compositions, for example “oxabetrinil” ((Z)-1,3-dioxolan-2-ylmethoxyimino(phenyl)acetonitrile) (S11-1), which is known as a seed-dressing safener for millet/sorghum against metolachlor damage,
   “fluxofenim” (1-(4-chlorophenyl)-2,2,2-trifluoro-1-ethanone O-(1,3-dioxolan-2-ylmethyl)oxime) (S11-2), which is known as a seed-dressing safener for millet/sorghum against metolachlor damage, and
   “cyometrinil” or “CGA-43089” ((Z)-cyanomethoxyimino(phenyl)acetonitrile) (S11-3), which is known as a seed-dressing safener for millet/sorghum against metolachlor damage.
S12) Active ingredients from the class of the isothiochromanones (S12), for example methyl [(3-oxo-1H-2-benzothiopyran-4(3H)-ylidene)methoxy]acetate (CAS Reg. No. 205121-04-6) (S12-1) and related compounds from WO-A-1998/13361.
S13) One or more compounds from group (S13):
   “naphthalic anhydride” (1,8-naphthalenedicarboxylic anhydride) (S13-1), which is known as a seed-dressing safener for maize against thiocarbamate herbicide damage,
   “fenclorim” (4,6-dichloro-2-phenylpyrimidine) (S13-2), which is known as a safener for pretilachlor in sown rice,
   “flurazole” (benzyl 2-chloro-4-trifluoromethyl-1,3-thiazole-5-carboxylate) (S13-3), which is known as a seed-dressing safener for millet/sorghum against alachlor and metolachlor damage,
   “CL 304415” (CAS Reg. No. 31541-57-8) (4-carboxy-3,4-dihydro-2H-1-benzopyran-4-acetic acid) (S13-4) from American Cyanamid, which is known as a safener for maize against damage by imidazolinones,
   “MG 191” (CAS Reg. No. 96420-72-3) (2-dichloromethyl-2-methyl-1,3-dioxolane) (S13-5) from Nitrokemia, which is known as a safener for maize,
   “MG 838” (CAS Reg. No. 133993-74-5) (2-propenyl 1-oxa-4-azaspiro[4.5]decane-4-carbodithioate) (513-6) from Nitrokemia
   “disulfoton” (0,0-diethyl S-2-ethylthioethyl phosphorodithioate) (S13-7),
   “dietholate” (O,O-diethyl O-phenyl phosphorothioate) (S13-8),
   “mephenate” (4-chlorophenyl methylcarbamate) (S13-9).
S14) Active ingredients which, in addition to herbicidal action against harmful plants, also have safener action on crop plants such as rice, for example “dimepiperate” or “MY-93” (S-1-methyl-1-phenylethylpiperidine-1-carbothioate), which is known as a safener for rice against damage by the herbicide molinate,
   “daimuron” or “SK 23” (1-(1-methyl-1-phenylethyl)-3-p-tolylurea), which is known as a safener for rice against damage by the herbicide imazosulfuron,
   “cumyluron”=“JC-940” (3-(2-chlorophenylmethyl)-1-(1-methyl-1-phenylethyl)urea, see JP-A-60087254), which is known as a safener for rice against damage by some herbicides,
   “methoxyphenone” or “NK 049” (3,3′-dimethyl-4-methoxybenzophenone), which is known as a safener for rice against damage by some herbicides,
   “CSB” (1-bromo-4-(chloromethylsulfonyl)benzene) from Kumiai, (CAS Reg. No. 54091-06-4), which is known as a safener against damage by some herbicides in rice.
S15) Compounds of the formula (S15) or tautomers thereof
   as described in WO-A-2008/131861 and WO-A-2008/131860,

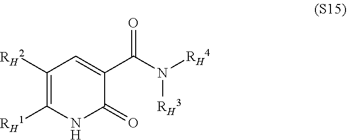

in which
R_{H}¹ is a (C₁-C₆)-haloalkyl radical and
R_{H}² is hydrogen or halogen and
R_{H}³, R_{H}⁴ are independently hydrogen, (C₁-C₁₆)-alkyl, (C₂-C₁₆)-alkenyl or (C₂-C₁₆)-alkynyl, where each of the 3 latter radicals is unsubstituted or substituted by one or more radicals from the group of halogen, hydroxyl, cyano, (C₁-C₄)-alkoxy, (C₁-C₄)-haloalkoxy, (C₁-C₄)-alkylthio, (C₁-C₄)-alkylamino, di[(C₁-C₄)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or (C₃-C₆)-cycloalkyl, (C₄-C₆)-cycloalkenyl, (C₃-C₆)-cycloalkyl fused on one side of the ring to a 4 to 6-membered saturated or unsaturated carbocyclic ring, or (C₄-C₆)-cycloalkenyl fused on one side of the ring to a 4 to 6-membered saturated or unsaturated carbocyclic ring,
      where each of the 4 latter radicals is unsubstituted or substituted by one or more radicals from the group of halogen, hydroxyl, cyano, (C₁-C₄)-alkyl, (C₁-C₄)-haloalkyl, (C₁-C₄)-alkoxy, (C1-C4)-haloalkoxy, (C1-C4)-alkylthio, (C1-C4)-alkylamino, di[(C1-C4)-alkyl]amino, [(C₁-C₄)-alkoxy]carbonyl, [(C₁-C₄)-haloalkoxy]carbonyl, (C₃-C₆)-cycloalkyl which is unsubstituted or substituted, phenyl which is unsubstituted or substituted, and heterocyclyl which is unsubstituted or substituted,
   or
R_{H}³ is (C₁-C₄)-alkoxy, (C₂-C₄)-alkenyloxy, (C₂-C₆)-alkynyloxy or (C₂-C₄)-haloalkoxy and
R_{H}⁴ is hydrogen or (C₁-C₄)-alkyl or
R_{H}³ and R_{H}⁴ together with the directly attached nitrogen atom represent a four- to eight-membered heterocyclic ring which, as well as the nitrogen atom, may also contain further ring heteroatoms, preferably up to two further ring heteroatoms from the group of N, O and S, and which is unsubstituted or substituted by one or more radicals from the group of halogen, cyano, nitro, (C₁-C₄)-alkyl, (C₁-C₄)-haloalkyl, (C₁-C₄)-alkoxy, (C₁-C₄)-haloalkoxy and (C1-C₄)-alkylthio.
S16) Active ingredients which are used primarily as herbicides but also have safener action on crop plants, for example
   (2,4-dichlorophenoxy)acetic acid (2,4-D), (4-chlorophenoxy)acetic acid, (R,S)-2-(4-chloro-o-tolyloxy)propionic acid (mecoprop), 4-(2,4-dichlorophenoxy)butyric acid (2,4-DB), (4-chloro-o-tolyloxy)acetic acid (MCPA), 4-(4-chloro-o-tolyloxy)butyric acid, 4-(4-chlorophenoxy)butyric acid, 3,6-dichloro-2-methoxybenzoic acid (dicamba), 1-(ethoxycarbonyl)ethyl 3,6-dichloro-2-methoxybenzoate (lactidichlor-ethyl).

Preferred safeners are: cloquintocet-mexyl, cyprosulfamide, fenchlorazole-ethyl, isoxadifen-ethyl, mefenpyr-diethyl, fenclorim, cumyluron.

Particularly preferred safeners are: cloquintocet-mexyl, cyprosulfamide, isoxadifen-ethyl and mefenpyr-diethyl.

Very particular preference is given to: mefenpyr-diethyl.

AS/ha:

Where the abbreviation “AS/ha” is used in the present description, it means “active substance per hectare”, based on 100% active ingredient. All percentages in the description are percent by weight (abbreviation: “% by weight”) and, unless defined otherwise, refer to the relative weight of the respective component based on the total weight of the herbicidal mixture/composition (for example as formulation).

The herbicidal compositions according to the invention can also be used for control of harmful plants in crops of genetically modified plants which are known or are yet to be developed.

In general, the transgenic plants are characterized by particular advantageous properties, for example by resistances to certain pesticides, in particular certain herbicides, resistances to plant diseases or pathogens of plant diseases, such as certain insects or microorganisms such as fungi, bacteria or viruses. Other particular properties relate, for example, to the harvested material with regard to quantity, quality, storability, composition and specific constituents. For instance, there are known transgenic plants with an elevated starch content or altered starch quality, or those with a different fatty acid composition in the harvested material. Other particular properties may be tolerance or resistance to abiotic stressors, for example heat, low temperatures, drought, salinity and ultraviolet radiation.

Conventional ways of producing novel plants which have modified properties in comparison to existing plants consist, for example, in traditional cultivation methods and the generation of mutants. Alternatively, novel plants with modified properties can be generated with the aid of recombinant methods (see, for example, EP-A-0221044, EP-A-0131624). For example, there have been descriptions in several cases of:
genetic modifications of crop plants for the purpose of modifying the starch synthesized in the plants (for example WO 92/11376, WO 92/14827, WO 91/19806),
transgenic crop plants which are resistant to particular herbicides of the glufosinate type (cf., for example, EP-A-0242236, EP-A-242246) or glyphosate type (WO 92/00377) or of the sulfonylurea type (EP-A-0257993, U.S. Pat. No. 5,013,659),
transgenic crop plants, for example cotton, with the ability to produce Bacillus thuringiensis toxins (Bt toxins), which make the
   plants resistant to particular pests (EP-A-0142924, EP-A-0193259),
transgenic crop plants having a modified fatty acid composition (WO 91/13972),
genetically modified crop plants with novel constituents or secondary metabolites, for example novel phytoalexins, which bring about an increased disease resistance (EPA 309862, EPA0464461),
genetically modified plants having reduced photorespiration, which have higher yields and higher stress tolerance (EPA 0305398),
transgenic crop plants which produce pharmaceutically or diagnostically important proteins (“molecular pharming”),
transgenic crop plants which feature higher yields or better quality,
transgenic crop plants which feature a combination, for example, of the abovementioned novel properties (“gene stacking”).

Numerous molecular biology techniques which can be used to produce novel transgenic plants with modified properties are known in principle; see, for example, I. Potrykus and G. Spangenberg (eds.) Gene Transfer to Plants, Springer Lab Manual (1995), Springer Verlag Berlin, Heidelberg, or Christou, “Trends in Plant Science” 1 (1996) 423-431.

For such genetic manipulations, nucleic acid molecules which allow mutagenesis or sequence alteration by recombination of DNA sequences can be introduced into plasmids. With the aid of standard methods, it is possible, for example, to undertake base exchanges, remove parts of sequences or add natural or synthetic sequences. For the connection of the DNA fragments to one another, it is possible to add adapters or linkers to the fragments; see, for example, Sambrook et al., 1989, Molecular Cloning, A Laboratory Manual, 2nd ed., Cold Spring Harbor Laboratory Press, Cold Spring Harbor, NY; or Winnacker “Gene und Klone” [Genes and Clones], VCH Weinheim, 2nd edition, 1996.

For example, the generation of plant cells with a reduced activity of a gene product can be achieved by expressing at least one corresponding antisense RNA, a sense RNA for achieving a cosuppression effect, or by expressing at least one suitably constructed ribozyme which specifically cleaves transcripts of the abovementioned gene product.

To this end, it is firstly possible to use DNA molecules which encompass the entire coding sequence of a gene product inclusive of any flanking sequences which may be present, and also DNA molecules which only encompass portions of the coding sequence, in which case it is necessary for these portions to be long enough to have an antisense effect in the cells. It is also possible to use DNA sequences which have a high degree of homology to the coding sequences of a gene product, but are not completely identical to them.

When expressing nucleic acid molecules in plants, the protein synthesized may be localized in any desired compartment of the plant cell. However, to achieve localization in a particular compartment, it is possible, for example, to join the coding region to DNA sequences which ensure localization in a particular compartment. Such sequences are known to those skilled in the art (see, for example, Braun et al., EMBO J. 11 (1992), 3219-3227; Wolter et al., Proc. Natl. Acad. Sci. USA 85 (1988), 846-850; Sonnewald et al., Plant J. 1 (1991), 95-106). The nucleic acid molecules can also be expressed in the organelles of the plant cells.

The transgenic plant cells can be regenerated by known techniques to give rise to entire plants. In principle, the transgenic plants may be plants of any desired plant species, i.e. not only monocotyledonous but also dicotyledonous plants.

Obtainable in this way are transgenic plants having properties altered by overexpression, suppression or inhibition of homologous (=natural) genes or gene sequences or expression of heterologous (=foreign) genes or gene sequences.

Preferably the compositions according to the invention can be used in transgenic crops which are resistant to growth regulators such as, for example, dicamba, or to herbicides which inhibit essential plant enzymes, for example acetolactate synthases (ALS), EPSP synthases, glutamine synthases (GS) or hydroxyphenylpyruvate dioxygenases (HPPD), or to herbicides from the group of the sulfonylureas, the glyphosates, glufosinates or benzoylisoxazoles and analogous active ingredients.

When the compositions according to the invention are employed in transgenic crops, not only do the effects toward harmful plants observed in other crops occur, but frequently also effects which are specific to application in the particular transgenic crop, for example an altered or specifically widened spectrum of weeds which can be controlled, altered application rates which can be used for the application, preferably good combinability with the herbicides to which the transgenic crop is resistant, and influencing of growth and yield of the transgenic crop plants.

The invention therefore also provides for the use of the compositions according to the invention for control of harmful plants in transgenic crop plants.

Preference is given to the use of the compositions according to the invention in economically important transgenic crops of useful plants and ornamentals, for example of cereals (e.g. wheat, barley, rye, oats), millet/sorghum, rice, cassava and maize, or else crops of sugar beet, cotton, soya, oilseed rape, potato, tomato, peas and other vegetable crops, especially in maize, cotton and soya.

The invention therefore also provides for the use of the compositions according to the invention for control of harmful plants in transgenic crop plants or crop plants having tolerance through selective breeding.

Components A and B can be converted together or separately to customary formulations, for example for application by atomizing, watering and spraying, such as solutions, emulsions, suspensions, powders, foams, pastes, granules, aerosols, active ingredient-impregnated natural and synthetic substances, microencapsulations in polymeric substances. The formulations may comprise the customary auxiliaries and additives.

These formulations are produced in a known manner, for example by mixing components A and B with extenders, i.e. liquid solvents, pressurized liquefied gases and/or solid carriers, optionally with use of surfactants, i.e. emulsifiers and/or dispersants and/or foam formers.

When the extender used is water, it is also possible to use, for example, organic solvents as auxiliary solvents. Useful liquid solvents are essentially: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and the ethers and esters thereof, ketones such as acetone, methyl ethyl ketone, methyl isobutyl ketone or cyclohexanone, strongly polar solvents such as dimethylformamide or dimethyl sulfoxide, and water.

Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; useful solid carriers for granules include: for example crushed and fractionated natural rocks, such as calcite, marble, pumice, sepiolite, dolomite and synthetic granules of inorganic and organic flours, and granules of organic material, such as sawdust, coconut shells, corn cobs and tobacco stalks; useful emulsifiers and/or foam formers include: for example nonionic and anionic emulsifiers, such as polyoxyethylene fatty acid esters, polyoxyethylene fatty alcohol ethers, e.g. alkylaryl polyglycol ethers, alkylsulfonates, alkylsulfates, arylsulfonates and protein hydrolysates; useful dispersants include: for example lignosulfite waste liquors and methylcellulose.

Tackifiers, such as carboxymethyl cellulose, natural and synthetic polymers in the form of powders, granules or latices, such as gum arabic, polyvinyl alcohol and polyvinyl acetate, and also natural phospholipids, such as cephalins and lecithins, and synthetic phospholipids can be used in the formulations. Further additives may be mineral and vegetable oils.

It is possible to use colorants such as inorganic pigments, for example iron oxide, titanium oxide and Prussian blue, and organic colorants such as alizarin colorants, azocolorants and metal phthalocyanine colorants, and trace nutrients such as salts of iron, manganese, boron, copper, cobalt, molybdenum and zinc.

In general, the formulations contain between 0.1 and 95 percent by weight of the components A and B, preferably between 0.5 and 90% by weight.

Components A and B, as such or in formulations thereof, can also be used as a mixture with other active agrochemical ingredients for controlling unwanted vegetation, for example for controlling weeds or for controlling unwanted crop plants, in which case finished formulations or tankmixes, for example, are possible.

Also possible are mixtures with other known active ingredients such as fungicides, insecticides, acaricides, nematicides, bird antifeedants, plant nutrients and soil improvers, and likewise with additives and formulation auxiliaries customary in crop protection.

Components A and B can be used as such, in the form of their formulations or in the use forms prepared therefrom by further dilution, such as ready-to-use solutions, suspensions, emulsions, powders, pastes and granules. Application is typically accomplished, for example, by watering, sprinkling, spraying, broadcasting.

Components A and B can be applied to the plants, plant parts or area under cultivation (soil), preferably to the green plants and plant parts, and to the soil. One possible use is the joint application of the active ingredients in the form of tankmixes, where the optimally formulated concentrated formulations of the individual active ingredients together are mixed in a tank with water, and the spray liquor obtained is deployed.

For application, the formulations in the commercial form are diluted if appropriate in a customary manner, for example with water in the case of wettable powders, emulsifiable concentrates, dispersions and water-dispersible granules. Preparations in dust form, granules for soil application or granules for scattering and sprayable solutions are not normally diluted further with other inert substances prior to application.

### Biological Examples

This study was conducted in order to examine possible synergism between the herbicides cinmethylin and ethofumesate.

### Material and Methods

The following plant species were selected for the tests:

| Target | Abbreviation | Species |
|---|---|---|
| Alopecurus myosuroides | ALOMY | blackgrass |
| Avena fatua | AVEFA | common wild oat |
| Lolium rigidum | LOLRI | ryegrass, rigid |
| Abuthilon theophrasti | ABUTH | velvet leaf |
| Matricaria inodora | MATCH | chamomile, false |
| Veronica persica | VERPE | persian speedwell |

The seeds of the abovementioned biotypes were sown in 8 cm pots (LSI; pH 7.4; % C org 2.2). The temperature was kept at about 23°/15° C. day/night. After the herbicides had been applied (300 l water/ha), the pots were irrigated from beneath as required. Two trials were conducted. In a pre-emergence trial, the herbicides were applied directly after sowing at the BBCH 00 growth stage. In a post-emergence trial, the herbicides were deployed at the BBCH 11-12 growth stage.

The active herbicidal ingredient cinmethylin was used as commercial emulsifiable concentrate (EC) LUMIMAX. Ethofumesate was used in the form of the commercial suspension concentrate (SC) Nortron. A methylated seed oil (Mero) was added to the spray liquids in an amount of 1 l/ha in order to assure good retention characteristics.

### Assessment

The percentage of weed control (2 repetitions) was rated 27 days after the application of herbicide (DAA) on a scale of 0-100. A rating of 0 means no control, and 100 means complete control.

### Calculation of Synergism According to Colby

According to Colby, synergistic effects of active herbicidal ingredients are indicated when the measured efficacy is higher than that expected, which is calculated by its formula for 2-substance mixtures: EC=A+B−(A×B)/100

### Results and Conclusions

### Trials of Post-Emergence Method

The 2-substance mixture of cinmethylin and ethofumesate, according to Colby, showed synergistic effects against the weeds tested. In the case of ALOMY, LOLRI, ABUTH and MATIN, cinmethylin and ethofumesate had synergistic action.

TABLE 1
Efficacy of cinmethylin and ethofumesate against dicotyledonous
and monocotyledonous weeds by the post-emergence method

| | | dose rate | | | | |
|---|---|---|---|---|---|---|
| Formulation | Active Ingredient | in g ai/ha | ALOMY | LOLRI | ABUTH | MATIN |
| LUMILUX | Cinmethylin | 25 | | | | 20 |
| LUMILUX | Cinmethylin | 100 | 78 | 63 | 35 | |
| Nortron | Ethofumesate | 20 | 0 | 0 | 0 | |
| Nortron | Ethofumesate | 50 | | | | 10 |
| LUMILUX + | Cinmethylin + | 25 + 50 | | | | 65 |
| Nortron | ethofumesate | | | | | |
| LUMILUX + | Cinmethylin + | 100 + 20 | 90 | 80 | 60 | |
| Nortron | ethofumesate | | | | | |
| LUMILUX + | Cinmethylin + | | 78 | 63 | 35 | 28 |
| Nortron | ethofumesate | | | | | |
| (calculated E) | | | | | | |
| Synergy (yes/no) | | | yes | yes | yes | yes |

### Trials of Pre-Emergence Method

The 2-substance mixture of cinmethylin and ethofumesate, according to Colby, showed synergistic effects against the weeds tested. In the case of AVEFA, MATIN and VERPE, cinmethylin and ethofumesate had synergistic action.

TABLE 2
Efficacy of cinmethylin and ethofumesate against dicotyledonous
and monocotyledonous weeds pre-emergence

| | Active | dose rate | | | |
|---|---|---|---|---|---|
| Formulation | Ingredient | in g ai/ha | AVEFA | MATIN | VERPE |
| LUMILUX | Cinmethylin | 50 | | 70 | 20 |
| LUMILUX | Cinmethylin | 100 | 70 | | |
| Nortron | Ethofumesate | 10 | | 0 | 0 |
| Nortron | Ethofumesate | 20 | 0 | | |
| LUMILUX + | Cinmethylin + | 50 + 10 | | 88 | 90 |
| Nortron | ethofumesate | | | | |
| LUMILUX + | Cinmethylin + | 100 + 20 | 78 | | |
| Nortron | ethofumesate | | | | |
| LUMILUX + | Cinmethylin + | | 70 | 70 | 20 |
| Nortron | aclonifen | | | | |
| (calculated E) | | | | | |
| Synergy | | | yes | yes | yes |
| (yes/no) | | | | | |

1. A method of controlling harmful plants in crops of useful plants, characterized in that an herbicidal composition comprising active herbicidal ingredients
(A) cinmethylin, and
(B) ethofumesate
are applied to at least one of the harmful plants, the useful plants, plant seeds of the useful plants, and area in which the useful plants grow.

2. The method of claim 1, further characterized in that
(A) cinmethylin, and
(B) ethofumesate
are the sole active herbicidal ingredients of the herbicidal composition.

3. The method of claim 2, further characterized in that the herbicidal composition comprises a safener.

4. The method according to claim 3, wherein the safener is isoxadifen-ethyl, cyprosulfamide, mefenpyr-diethyl or cloquintocet-mexyl, including salts and hydrates thereof.

5. The method according to claim 1, wherein the herbicidal composition contains cinmethylin and ethofumesate in a weight ratio of 0.1 to 10.

6. The method according to claim 1, characterized in that the useful plants come from the group of maize, cotton or soya.

7. The method according to claim 1, characterized in that the useful plants have been genetically modified.

8. The method according to claim 1, characterized in that the method is implemented by a pre-emergence or early post-emergence method.

9. The method according to claim 1, characterized in that the method is conducted for control of HPPD-resistant plants.

10. (canceled)

11. (canceled)

12. The method according to claim 1, characterized in that cinmethylin is used at an application rate of 200 to 500 g and ethofumesate at an application rate of 100 to 250 g per hectare.

13. An herbicidal composition for controlling harmful plants in crops of useful plants comprising:
(A) cinmethylin; and
(B) ethofumesate.

14. The herbicidal composition of claim 13, wherein cinmethylin and ethofumesate are the sole active herbicidal ingredients of the herbicidal composition.

15. The herbicidal composition of claim 14, further comprising a safener.

16. The herbicidal composition of claim 15, wherein the safener is isoxadifen-ethyl, cyprosulfamide, mefenpyr-diethyl or cloquintocet-mexyl, including salts and hydrates thereof.

17. The herbicidal composition of claim 13, wherein the cinmethylin and ethofumesate are present in a weight ratio of 0.1 to 10.
